(19) United States
(12) Patent Application Publication
(10) Pub. No.: US 2010/0104713 A1
(43) Pub. Date: Apr. 29, 2010

(54) Method for Custom Decorating of Bakery Items

(76) Inventor: April M. Didrikson, Lufkin, TX (US)

Correspondence Address: DARCELL WALKER, 8107 CARVEL LANE, HOUSTON, TX, 77036, US

(21) Appl. No.: 12/257,186

(22) Filed: Oct. 23, 2008

(51) Int. Cl. A23P 1/08

(52) U.S. Cl. 426/383

(57) ABSTRACT

A method for decorating or coloring the surface of a baking item applies a sheet of edible material to a surface of the baking item. Prior to applying the sheet of edible material to the surface of the baking item, a line drawing of some design, image or picture will be applied to the sheet of edible material. The line drawing will be in sections with each section having a number. A color ledger can be generated that comprises a set of numbers and colors associated with each number. The numbers of the color ledger correspond with or are related to the numbers on the line drawing. A section of the line drawing is colored with the color that corresponds to that number in the color ledger. This method provides the user with the flexibility to create custom designs instead of limited by preexisting design features.

### FIELD OF THE INVENTION

This invention relates to a method and system for decorating baking items and more particularly to methods and system for applying custom designs and coloring decorations to baking items such as cakes, cupcakes and cookies using edible baking materials.

### BACKGROUND OF THE INVENTION

A standard practice in baking is to decorate the baking item in order to enhance the appearance of the baking item. These decorations include colored icings and creams applied to the surface of a baking item to produce a colored surface and various kinds of symbols and figures. In addition, other artificial props such as candles are also applied to the surface of a baking item to further decorate the item. Other edible props are also applied to these baking items.

Currently, there are two standard methods for decorating items. The oldest and more traditional method is to place an edible decorative design directly onto the baking item. In this method, the decorator relies on his or her own artistic ability or uses some device for aid in placing the design on the item. One such device referred to as a KOPYKAKE projects an optical image onto a cake so that a decorator can apply a decoration to the cake, using the projected image as a guide. Another method uses a decorating stamp such as that described in U.S. Pat. No. 3,446,143. The apparatus includes a stamp having individual sections movable with respect to one another. Various materials of disparate colors are applied to different sections of the stamp and then the sections are held in registry such that the sections form a composite unit capable of impressing the multiple colors upon the confectionery to render a complete design.

U.S. Pat. No. 3,852,494 also describes a stamp method for decorating a confectionery item. The steps include applying a lining material to a design stamp, applying and then removing the stamp from a surface of the confectionery item. This step leaves a delineated design in the surface of the confectionery item. Thereafter, fill material to color and decorate the item is applied to the item surface. A stamp for performing the method can have various configurations and can include integral elongated pieces being triangular in cross-section and terminating downwardly at elongated apices delineating the design provided by the stamp. An alternate stamp includes an integral supporting web from which the elongated members depend. A handle for grasping and supporting either stamp is located in a position offset from a central portion of the stamp.

Although these devices enable the decorator to accomplish the objective of decorating a baking item, these devices, have several inherent disadvantages. For example, the KOPYKAKE device is relatively expensive, when compared to the more economical hand stamp such as that disclosed in my previous patent. Hand stamps such as mentioned above are relatively inflexible in that they are commonly used to apply a fixed complete colored design. In a multiple color operation, such stamps require manipulation of their various sections during the application of coloring material thereto.

The second and currently highly popular method of decorating baking items is to apply a colored image to a sheet of edible material and then apply the edible material with the colored image to the baking item. This method involves using an edible sheet material and colored edible ink. In this method, a desirable image, usually a colored picture or photograph is inserted into a copier. The edible sheet material is then fed into the copier in a similar manner to feeding a sheet of paper into a copier. In this method, the picture is copied onto the edible sheet material in the same manner as in a typical copier. The image on the edible sheet material is then placed on the baking item. For example, if person wanted a cake with the image of a super hero on it, a color image of the super hero is placed on the glass of the copier. A sheet of edible material is placed in the tray. When the user presses the “START COPY” button, the edible sheet material is fed into the copier and the image of the super hero is copied onto the edible sheet material.

U.S. Pat. No. 4,024,287 describes a method of decorating various confectionary food items such as cakes, pies and the like which includes the steps of placing a transparent shield over a selected design to be transferred to the food item, placing a sheet of thin transfer medium over the shield and design to be traced, tracing said design on the transfer medium using edible ink, placing the transfer medium on the food item to be decorated with the colored side down, and placing a damp pad on the exposed back face of the transfer medium, thereby causing the traced design to be transferred to the food item.

Another method for decorating baking goods, U.S. Pat. No. 4,910,661, describes an automatic decorating machine for applying flowable decorative materials to cakes and other food products as well as other articles. Live video images are captured by a video camera and are displayed on a video monitor. The video image can be combined with textual messages composed from alphanumeric characters and with artwork, which can either be composed contemporaneously on site or selected from previously prepared artwork selections. The video image, artwork and text can be edited and combined as desired for display on the monitor to provide a preview of the decorating pattern. The displayed pattern is reproduced on the cake by an X-Y table which moves liquid spray applicators and icing or gel dispensers over the cake and controls the application of food coloring and icing or gel in a manner to reproduce the selected pattern on the cake.

U.S. Pat. No. 6,616,958 describes an edible film and method of making and using it for decorating foodstuffs, in particular baked goods, wherein anyone can easily, inexpensively and artistically decorate foodstuffs. The edible film according to the present invention is composed of an edible polymer film, which is preferably releasably mounted upon a flexible substrate to provide a reinforced edible film. The edible film is peelably released from the substrate to provide decorations for the foodstuff. The edible film may be decoratively prepared into predetermined decorations prior to distribution, which may include being pre-printed, pre-cut, colored, or being of pre-selected opacity and sheen. Alternatively, the edible film may be distributed in a not yet finalized decoration form, wherein finalization is left up to the user.

Although these methods for decorating baking goods are quite efficient in creating colorful images, these methods eliminate the need for creative abilities that some customers prefer. In particular, U.S. Pat. No. 6,616,958 provides one of the most advanced approaches, it steps are complex and probably not feasible or desirable for this type of activity. There remains a need for a method and system that can enable bakery item decorators to create custom decorative items.

### SUMMARY OF THE INVENTION

The method of the present invention is designed for a professional cake designer or an at home consumer to create what appears to be custom decorated baking items such as cakes, cupcakes, cookies, etc. Embodiments of the present invention provide a method for decorating or coloring the surface of a baking item. This method applies a sheet of edible material to a surface of the baking item. Prior to applying the sheet of edible material to the surface of the baking item, a line drawing of some design or picture will be applied to the sheet of edible material. The line drawing will be in sections with each section having a number. A color ledger is generated and comprises a set of numbers and colors associated with each number. The numbers of the color ledger correspond with or are related to the numbers on the line drawing. In this method, a section of the line drawing is to be colored with the color that corresponds to that number in the color ledger.

In the method of the invention, an image is identified with defined sections that will have specified colors. A color ledger is generated having a list of colors and associated numbers. The image is then applied to an edible sheet material. This sheet material is placed on the surface of a baking item. Color material such as icing or cream is applied to each section of the display in accordance with the numbers and colors in the ledger.

### DESCRIPTION OF THE DRAWINGS

FIG. 1 is an example of an image that can be applied to the surface of a baking item.

FIG. 2 is a color ledger of colors and associated numbers for coloring an image positioned on a bakery item.

FIG. 3 is a flow diagram of an embodiment of the general method of the present invention.

FIG. 4 is a flow diagram of an embodiment of the present invention in which coordinates define sections of the image displayed on a baking item.

FIG. 5 is a flow diagram of an embodiment of the method of present invention for a flat cake bakery item.

FIG. 6 is an example of a display image on a grid having coordinates that identify sections of the display image.

### DETAILED DESCRIPTION OF THE INVENTION

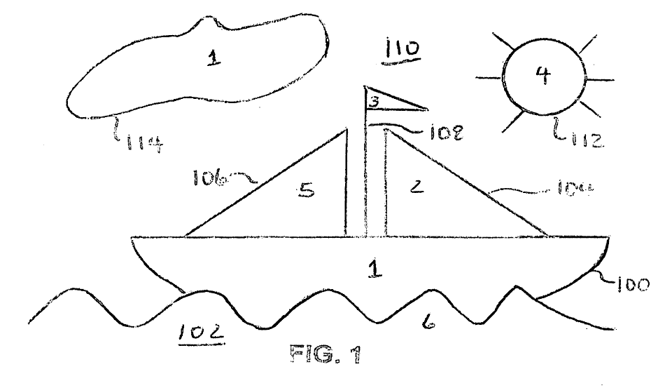

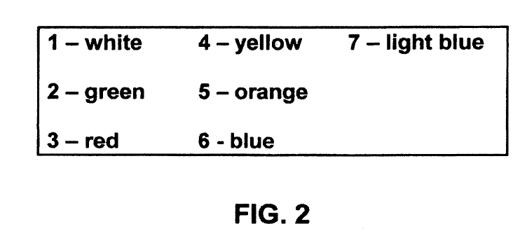

The description and application of the invention will be described in the context of cake as the bakery item. Shown in FIG. 1 is an image of a boat 100 sailing in water 102. Multiple sections can define the objects in this image. The boat 100 has two sails 104 and 106. Also shown on the boat is a flagpole and flag 108. This scene also shows sky 110 with the sun 112 and a cloud 114. Each image in the scene is assigned a number that will be coordinated with the color ledger. Each assigned number in the ledger has an associated color for that image. In this scene, the boat and the cloud both have an assigned number of ‘1’. As will be seen in the ledger in FIG. 2, the number ‘1’ is associated with the color white. Both of these images will be colored white. In the boat image described FIG. 1, each image will only have one color. In some scenes, a particular object may have multiple colors. In that situation, the specific object could be divided into sections with each section of the object having a defined color. FIG. 2 is the color ledger with colors and associated numbers for coloring an image positioned on a bakery item. This ledger shows seven colors and associated numbers. However, the number of colors in the ledger can vary and will be at the discretion of the user.

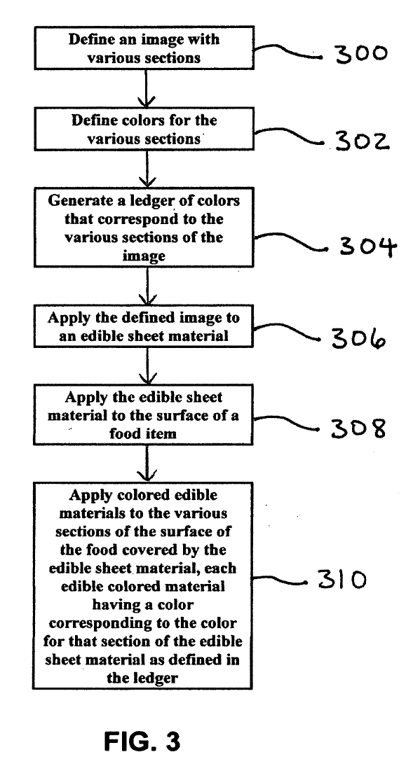

The embodiments of the present invention do have features that are similar to the general paint-by-numbers concept used for coloring pictures. However, the method of the present invention incorporates additional features for custom decorating of baking items such as flat cakes and non-flat cakes. FIG. 3 is a flow diagram of the general method of the present invention. In this method, step 300 defines an image to be positioned on a baking item. The preferred application is baking items such as cakes that have flat surfaces. For purposes of this discussion, in this step 300, the image to be defined as the sail boat image shown in FIG. 1. This sailboat image has seven sections. In step 300, each of the seven sections will be identified. After identifying the sections of the image, step 302 defines the colors for each section of the image. In the automated version of the method, the user can respond to prompts to provide information about the color of each section. Step 304 generates a ledger of colors that correspond with the various sections of the image. This ledger creation step can occur prior to step 302, which defines the desired colors for each section of the image. At this point, step 306 applies an outline of the defined image with the various sections to an edible sheet material. This outline application step is crucial and is different from conventional uses of edible sheet material. In the conventional method the entire image including colors is applied to the edible sheet material. The conventional method limits the amount of creativity of the user preparing the baking item. Once the user has applied the outline of the edible image to the edible material, step 308 applies the edible sheet material containing the image outline to the surface of the baking item. Step 310 applies colored edible materials to the various sections of the surface of the food covered by the edible sheet material, each edible colored material having a color corresponding to the color for that section of the edible sheet material as defined in the ledger.

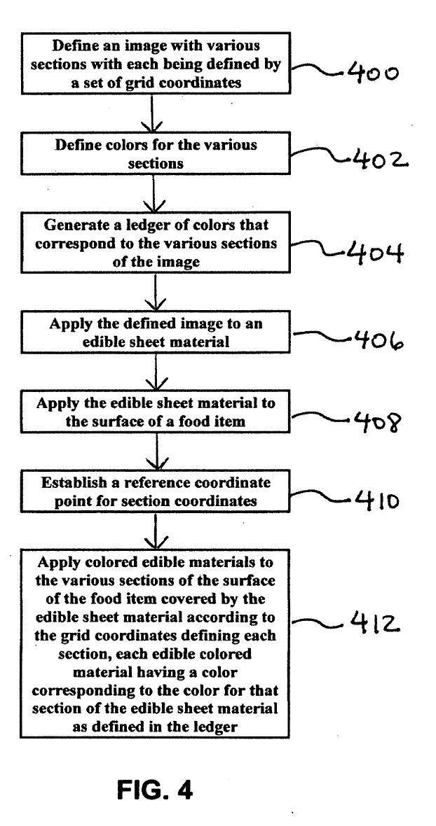

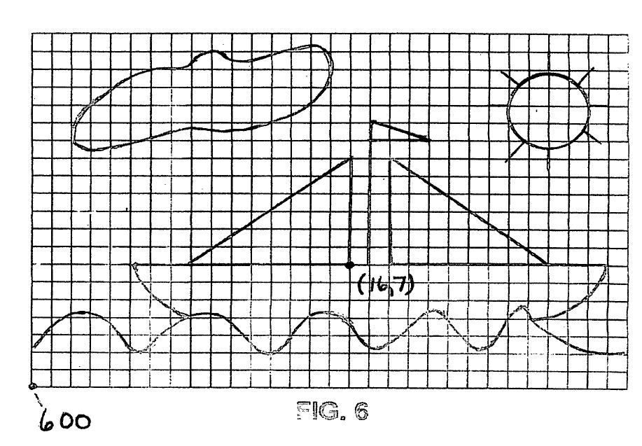

FIG. 4 is a flow diagram of an embodiment of the present invention in which coordinates define sections of the image displayed on a baking item. This method can be used in an automated application of the present invention. This application could be used with FIG. 6. Referring to FIG. 6 shown is a display image on a grid having coordinates that identify sections of the display image. The grid can have a reference point 600 from which, both vertical and horizontal coordinates are based. In addition to the grid, the present invention can have a set of geometric shapes such as circles, triangles and squares. The shapes can be inserted into images that contain these shapes. For example, in FIG. 1, there are three triangle shapes and one circle. In addition, with regard to triangles, the various types of triangles (isosceles and equilateral) can be included in a database of geometric shapes. For these geometric shapes, one coordinate and the known shape could be enough to identify the shape and location of a section on the image. For example, section 5 of FIG. 1 has a geometric shape of an isosceles triangle. In FIG. 6, assuming that every line is a unit, the bottom end point of the vertical line is 16-horizontal and 7-vertical (16, 7). Knowing the length of that vertical segment, the bottom end coordinate the vertical segment, the length of the horizontal segment and the fact that the shape is an isosceles triangle, the present invention has the capability to color that section in the shape of the shown on the image. Referring to FIG. 4, in step 400, each section of the image can be defined by a series of coordinate points. Each section can be also be assigned an identifying number. Step 402 defines the color for each section in the image. The user can supply this information. With this information, step 404 can generate a ledger of colors that correspond to the various sections of the image. An alternative to generating a ledger in step 404 is to have a pre-existing ledger of colors and associated numbers. As in step 306, step 406 applies an outline of the defined image with the various sections to an edible sheet material. After the outline of the image has been applied to the edible material, step 408 applies the edible sheet material containing the image outline to the surface of the baking item. If not performed in step 400, step 410 establishes a reference coordinate point for section coordinates. Step 412 then applies colored edible materials to the various sections of the surface of the food item covered by the edible sheet material according to the grid coordinates defining each section. As mentioned, each edible colored material having a color corresponding to the color for that section of the edible sheet material as defined in the ledger.

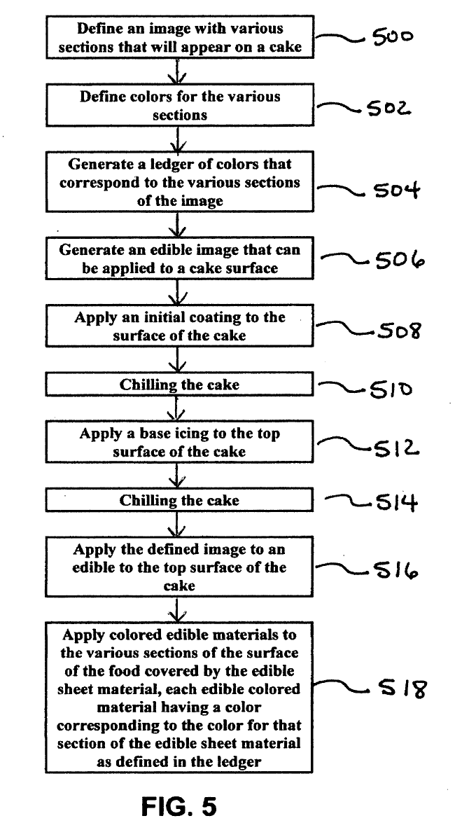

FIG. 5 is a flow diagram of an embodiment of the method of present invention for a flat cake bakery item. This process can be described in two phases: 1) image preparation and 2) cake preparation. In the image preparation phase, as with the previously described method embodiments, step 500 defines an image with various sections that will appear on a cake. Step 502 defines colors for the various sections of the image. There are various ways for accomplishing this step including having a predefined ledger of colors and associated numbers. Step 504 can also generate a ledger of colors that correspond to the various sections of the image. Next, in step 506, the image for the cake surface is generated in an outline form and applied to an edible sheet material that will be positioned on the surface of the cake.

At this point, the cake preparation phase begins by applying an initial coating to the surface of the cake in step 508. Step 510 chills the cake. The chilling step is to allow the initial cake coating to settle and solidify on the cake surface. The time allowed for the cake to chill can be in the discretion of the user. Step 512 applies a base icing to the top surface of the cake over the initial coating. The fact that the coating is chilled makes the application of the icing a more efficient process. After the application of the icing, another cake chilling activity occurs in step 514. This chilling step allows the icing to settle and solidify on the cake surface. After the completion of this chilling step 514, step 516 applies the edible sheet material containing the defined image to the top surface of the cake. Lastly step 518 applies colored edible materials to the various sections of the surface of the food covered by the edible sheet material, each edible colored material having a color corresponding to the color for that section of the edible sheet material as defined in the ledger.

In addition to the method of decorating a baking item, the present invention can also have an embodiment in which the baking item can be prepared in sections and then assembled to reflect one finished product. For example, there may a scene containing two ships. One ship can be prepared as the first section and the second ship can be prepared separately as the second image. The two images can then be positioned adjacent each other to produce a single image having both ships. Further, depending on the size of the baking item, this approach may be optimal.

Another embodiment of the present invention provides for custom shaping of the baking in accordance with the image. This method provides for the cutting of the edges up to the sections of the image. In the image of FIG. 1, the bottom edge of the baking item can be cut to have a wave shape. In addition, the top of the baking item can have a varied shape to resemble a sky.

The method of this invention provides significant advantages over the current art. The invention has been described in connection with its preferred embodiments. However, it is not limited thereto. Changes, variations and modifications to the basic design may be made without departing from the inventive concepts in this invention. In addition, these changes, variations and modifications would be obvious to those skilled in the art having the benefit of the foregoing teachings. All such changes, variations and modifications are intended to be within the scope of this invention.

I claim:

1. A method for decorating the surface of a baking item comprising:
defining an image with various sections;
defining color for the various sections of the image;
applying an outline of the define image to an edible sheet material;
applies a sheet of edible material to a surface of the baking item; and
applying colored edible materials to the various sections of the design image in accordance with the define color for each section of the image.

2. The method as described in claim 1 further comprising after said color defining step, the step of generating a ledger of colors that correspond to the various sections of the image.

3. The method as described in claim 2 wherein said image defining step further comprises defining a set of grid coordinates for each section.

4. The method as described in claim 3 further comprising establishing a main reference point for the grid containing the image.

5. The method as described in claim 4 further comprising establishing a set of geometric shapes that can represent various sections of a defined image.

6. The method as described in claim 5 wherein said color applying step further comprises applying colored edible materials to the various sections of the image according to the grid coordinates that define each section of the image, the edible colored materials having a color corresponding to the color for that section of the edible sheet material as defined in the ledger.

7. The method as described in claim 1 further comprising after said color applying step, the step of trimming edges of the baking item, such that the edges contour to one or more sections of the image.

8. The method as described in claim 1 wherein said image defining step further comprises defining an image as multiple images.

9. The method as described in claim 8 further comprising after said color applying step, the step of assembling the multiple defined images such that the multiple defined images form on complete image on the baking item.
